(19) United States
(12) Patent Application Publication
(10) Pub. No.: US 2021/0291177 A1
(43) Pub. Date: Sep. 23, 2021

(54) REAGENT CARRIER FOR RAPID DIAGNOSTIC TESTS

(71) Applicant: Detect, Inc., Guilford, CT (US)

(72) Inventors: Jonathan M. Rothberg, Guilford, CT (US); Spencer Glantz, West Hartford, CT (US); Benjamin Rosenbluth, Hamden, CT (US); Todd Roswech, Ivoryton, CT (US); Eric Kauderer-Abrams, Redwood City, CA (US); Matthew Dyer, Spring, TX (US); Jose Camara, Saratoga, CA (US); Owen Kaye-Kauderer, Brooklyn, NY (US); John H. Leamon, Stonington, CT (US)

(73) Assignee: Detect, Inc., Guilford, CT (US)

(21) Appl. No.: 17/203,668

(22) Filed: Mar. 16, 2021

Related U.S. Application Data
(60) Provisional application No. 63/081,201, filed on Sep. 21, 2020.
(60) Provisional application No. 63/068,303, filed on Aug. 20, 2020.
(60) Provisional application No. 63/066,770, filed on Aug. 17, 2020.
(60) Provisional application No. 63/066,111, filed on Aug. 14, 2020.
(60) Provisional application No. 63/065,131, filed on Aug. 13, 2020.
(60) Provisional application No. 63/059,928, filed on Jul. 31, 2020.
(60) Provisional application No. 63/053,534, filed on Jul. 17, 2020.
(60) Provisional application No. 63/036,887, filed on Jun. 9, 2020.
(60) Provisional application No. 63/027,859, filed on May 20, 2020.
(60) Provisional application No. 63/027,874, filed on May 20, 2020.
(60) Provisional application No. 63/027,890, filed on May 20, 2020.
(60) Provisional application No. 63/027,864, filed on May 20, 2020.
(60) Provisional application No. 63/027,878, filed on May 20, 2020.
(60) Provisional application No. 63/027,886, filed on May 20, 2020.
(60) Provisional application No. 63/022,534, filed on May 10, 2020.
(60) Provisional application No. 63/022,533, filed on May 10, 2020.
(60) Provisional application No. 63/016,797, filed on Apr. 28, 2020.
(60) Provisional application No. 63/013,450, filed on Apr. 21, 2020.
(60) Provisional application No. 63/010,578, filed on Apr. 15, 2020.
(60) Provisional application No. 63/010,626, filed on Apr. 15, 2020.
(60) Provisional application No. 63/002,209, filed on Mar. 30, 2020.
(60) Provisional application No. 62/991,039, filed on Mar. 17, 2020.

(51) Int. Cl. B01L 3/00; B01L 7/00; B01L 1/00

(52) U.S. Cl. CPC B01L 3/502715; B01L 7/52; B01L 2200/10; B01L 2200/16; B01L 1/52

(57) ABSTRACT

A reagent carrier includes: a cap configured to fit on an opening of a reaction vessel; and a reagent confined by the cap. The cap may be configured to release the reagent when a user manipulates the cap while the cap is fitted on the opening of the reaction vessel. For example, the reagent may be released when the user twists the cap from a first position to a second position or when the user pushes on a surface of the cap. The cap may be configured to seal the opening of the reaction vessel when the cap is fitted on the opening of the reaction vessel. In some implementations, the cap may be a blister cap containing the reagent. In some implementations, the cap may include a cage containing the reagent. In some implementations, the cap may include a deformable structure containing the reagent.

### CROSS-REFERENCE TO RELATED APPLICATIONS

The present application claims the benefit of priority of U.S. Provisional Application No. 63/066,770 filed Aug. 17, 2020, entitled “APPARATUSES AND METHODS FOR PERFORMING RAPID DIAGNOSTIC TESTS” (Attorney Docket No. H0966.70014US28), the entire contents of which is incorporated by reference herein; and also claims the benefit of priority of U.S. Provisional Application No. 63/066,111 filed Aug. 14, 2020, entitled “APPARATUSES AND METHODS FOR PERFORMING RAPID DIAGNOSTIC TESTS” (Attorney Docket No. H0966.70014US27), the entire contents of which is incorporated by reference herein; and also claims the benefit of priority of U.S. Provisional Application No. 63/053,534 filed Jul. 17, 2020, entitled “COMPUTER VISION ALGORITHM FOR DIAGNOSTIC TESTING” (Attorney Docket No. H0966.70014US22), the entire contents of which is incorporated by reference herein; and also claims the benefit of priority of U.S. Provisional Application No. 63/027,886 filed May 20, 2020, entitled “RAPID SELF ADMINISTRABLE TEST” (Attorney Docket No. H0966.70014US20), the entire contents of which is incorporated by reference herein; and also claims the benefit of priority of U.S. Provisional Application No. 63/027,878 filed May 20, 2020, entitled “RAPID SELF ADMINISTRABLE TEST” (Attorney Docket No. H0966.70014US19), the entire contents of which is incorporated by reference herein; and also claims the benefit of priority of U.S. Provisional Application No. 63/027,864 filed May 20, 2020, entitled “RAPID SELF ADMINISTRABLE TEST” (Attorney Docket No. H0966.70014US18), the entire contents of which is incorporated by reference herein; and also claims the benefit of priority of U.S. Provisional Application No. 63/027,890 filed May 20, 2020, entitled “RAPID SELF ADMINISTRABLE TEST” (Attorney Docket No. H0966.70014US17), the entire contents of which is incorporated by reference herein; and also claims the benefit of priority of U.S. Provisional Application No. 63/027,874 filed May 20, 2020, entitled “RAPID SELF ADMINISTRABLE TEST” (Attorney Docket No. H0966.70014US16), the entire contents of which is incorporated by reference herein; and also claims the benefit of priority of U.S. Provisional Application No. 63/027,859 filed May 20, 2020, entitled “RAPID SELF ADMINISTRABLE TEST” (Attorney Docket No. H0966.70014US15), the entire contents of which is incorporated by reference herein; and also claims the benefit of priority of U.S. Provisional Application No. 63/068,303 filed Aug. 20, 2020, entitled “APPARATUSES AND METHODS FOR PERFORMING RAPID MULTIPLEXED DIAGNOSTIC TESTS” (Attorney Docket No. H0966.70014US14), the entire contents of which is incorporated by reference herein; and also claims the benefit of priority of U.S. Provisional Application No. 63/059,928 filed Jul. 31, 2020, entitled “RAPID DIAGNOSTIC TEST” (Attorney Docket No. H0966.70014US12), the entire contents of which is incorporated by reference herein; and also claims the benefit of priority of U.S. Provisional Application No. 63/065,131 filed Aug. 13, 2020, entitled “APPARATUSES AND METHODS FOR PERFORMING RAPID DIAGNOSTIC TESTS” (Attorney Docket No. H0966.70014US11), the entire contents of which is incorporated by reference herein; and also claims the benefit of priority of U.S. Provisional Application No. 63/081,201 filed Sep. 21, 2020, entitled “RAPID DIAGNOSTIC TEST” (Attorney Docket No. H0966.70014US10), the entire contents of which is incorporated by reference herein; and also claims the benefit of priority of U.S. Provisional Application No. 63/036,887 filed Jun. 9, 2020, entitled “RAPID DIAGNOSTIC TEST” (Attorney Docket No. H0966.70014US08), the entire contents of which is incorporated by reference herein; and also claims the benefit of priority of U.S. Provisional Application No. 63/022,533 filed May 10, 2020, entitled “RAPID DIAGNOSTIC TEST” (Attorney Docket No. H0966.70014US07), the entire contents of which is incorporated by reference herein; and also claims the benefit of priority of U.S. Provisional Application No. 63/022,534 filed May 10, 2020, entitled “RAPID DIAGNOSTIC TEST” (Attorney Docket No. H0966.70014US06), the entire contents of which is incorporated by reference herein; and also claims the benefit of priority of U.S. Provisional Application No. 63/016,797 filed Apr. 28, 2020, entitled “SAMPLE SWAB WITH BUILD-IN ILLNESS TEST” (Attorney Docket No. H0966.70014US05), the entire contents of which is incorporated by reference herein; and also claims the benefit of priority of U.S. Provisional Application No. 63/013,450 filed Apr. 21, 2020, entitled “METHOD OF MAKING AND USING A VIRAL TEST KIT” (Attorney Docket No. H0966.70014US04), the entire contents of which is incorporated by reference herein; and also claims the benefit of priority of U.S. Provisional Application No. 63/010,626 filed Apr. 15, 2020, entitled “VIRAL RAPID COLORIMETRIC TEST” (Attorney Docket No. H0966.70014US03), the entire contents of which is incorporated by reference herein; and also claims the benefit of priority of U.S. Provisional Application No. 63/010,578 filed Apr. 15, 2020, entitled “VIRAL RAPID TEST” (Attorney Docket No. H0966.70014US02), the entire contents of which is incorporated by reference herein; and also claims the benefit of priority of U.S. Provisional Application No. 63/002,209 filed Mar. 30, 2020, entitled “VIRAL RAPID TEST” (Attorney Docket No. H0966.70014US01), the entire contents of which is incorporated by reference herein; and also claims the benefit of priority of U.S. Provisional Application No. 62/991,039 filed Mar. 17, 2020, entitled “VIRAL RAPID TEST” (Attorney Docket No. H0966.70014US00), the entire contents of which is incorporated by reference herein.

### FIELD

The technology of the present invention relates generally to reagent carriers usable for carrying a reagent to be used in a test, e.g., a diagnostic test for detecting the presence of a target nucleic-acid sequence. More specifically, aspects of the technology of the present invention relate to reagent carriers useable in or with apparatuses, methods, components, and test kits, and configured to add one or more reagent(s) to a test procedure with little or no contact of the reagent(s) by a user.

### BACKGROUND

The ability to rapidly diagnose diseases—particularly highly communicable infectious diseases—is critical to preserving human health through early detection and containment of the infectious diseases until reliable preventive measures (e.g., vaccines) and/or medicinal treatments or cures are developed. Rapid testing is critical to determining infected individuals quickly and minimizing their interactions with others, in order to minimize the spread of the diseases. As one example, the high level of contagiousness, the high mortality rate, and the lack of an early treatment or vaccine for the coronavirus disease 2019 (COVID-19) have resulted in a pandemic that has already infected millions and killed hundreds of thousands of people. The existence of rapid, accurate diagnostic tests, useable for detecting COVID-19 as well as other diseases, could allow individuals infected with a disease to be quickly identified and isolated, which could assist with containment of the disease. In the absence of such diagnostic tests, diseases such as COVID-19 may spread unchecked throughout communities.

### SUMMARY

Provided herein are reagent carriers that enable reagents to be held and controllably added to a reaction vessel without requiring users to contact the reagents during the adding. The reagent carriers are useable in apparatuses, methods, and test kits that enable a lay person to perform diagnostic testing to detect one or more target nucleic-acid sequence(s). The diagnostic testing may involve rapid diagnostic tests performed in a point-of-care (POC) setting (e.g., a home, a school, and office, a library, etc.) without specialized equipment. The rapid diagnostic tests may be self-administered by subjects to be tested, and the reagent carriers may be used in the rapid diagnostic tests by subjects who are not laboratory-trained professionals.

According to an aspect of the present technology, a reagent carrier is provided that may be comprised of: a cap configured to fit on an opening of a reaction vessel; and a reagent confined by the cap.

In some embodiments of this aspect, the cap may be configured to release the reagent when a user manipulates the cap while the cap is fitted on the opening of the reaction vessel. In one example, the cap may be configured to release the reagent when the user twists the cap from a first position to a second position while the cap is fitted on the opening of the reaction vessel. In another example, the cap may be configured to release the reagent when the user pushes on a surface of the cap while the cap is fitted on the opening of the reaction vessel.

In some embodiments of this aspect, the cap may be a blister cap comprised of a blister pack configured to contain the reagent. The blister cap may be configured to release the reagent when the blister cap is pushed by a user to cause the blister pack to rupture and release the reagent from confinement.

In some embodiments of this aspect, the cap may be a caged cap comprised of a basket configured to contain the reagent. The basket may be structured to enable the reagent to form a solution with a liquid when the basket is at least partially immersed in the liquid.

In some embodiments of this aspect, the cap may be a releasable caged cap comprised of: a base portion configured to be attachable to the reaction vessel; and a retainer portion attached to the base portion and configured to contain the reagent. In one example, the retainer portion may be comprised of a plurality of fingers configured to retain the reagent relative to the base portion. In some cases, each of the plurality of fingers may be comprised of a tip configured to abut a surface of the reagent. The retainer portion may be configured to release the reagent when the base portion is attached to the reaction vessel. In some cases, the retainer portion may be comprised of a pliable elastomeric structure configured to deform to release the reagent during attachment of the base portion to the reaction vessel.

In some embodiments of this aspect, the reagent may be comprised of a lyophilized material. In some cases, the lyophilized material may be coated with time-release material. In some cases, the reagent may be comprised of: a pellet, a bead, a tablet, a capsule, or a gelcap. In some cases, the reagent may be stable under ambient temperatures and pressures. In some cases, the reagent may be active at room temperature. In one example, the reagent may be comprised of an amplification agent. In another example, the reagent may be comprised of a lysing agent.

In some embodiments of this aspect, the cap may be comprised of: an attachment portion configured to attach to the reaction vessel, and a flip-top lid movably attached to the attachment portion. The flip-top lid may be attached to the attachment portion by a hinge.

According to another aspect of the present technology, a method of using a reagent cap is provided. The method may be comprised of: covering an opening of a reaction vessel with a cap configured to fit on the opening of the reaction vessel, with the cap carrying a reagent; and triggering the reagent to be released from the cap into the reaction vessel. In some cases, the cap may be comprised of a blister pack containing the reagent, and the triggering may be comprised of pushing a blister of the blister pack to release the reagent from the cap. In some cases, the triggering may be comprised of twisting the cap relative to the reaction vessel or inverting the reaction vessel to enable a fluid to reach the reagent at the cap to dissolve the reagent into the reaction vessel. In some cases, the triggering may be comprised of causing a retainer portion of the cap to deform or break to release the reagent.

According to another aspect of the present technology, a method of manufacturing a reagent carrier is provided. The method may be comprised of inserting a reagent in a retainer portion of a cap, with the cap being configured to be attachable to a reaction vessel. The method may further be comprised of: attaching the retainer portion to a base portion of the cap. In some cases, the inserting occurs before the attaching. In some cases, the retainer portion may be comprised of a basket configured to enable a fluid to reach the reagent when the basket is immersed in the fluid. In some cases, the retainer portion may be comprised of a pliable structure configured to release the reagent into the reaction vessel during attachment of the cap to the reaction vessel.

According to another aspect of the present technology, a test kit is provided for use in a diagnostic test. The test kit may be comprised of: a reaction vessel; and a first cap comprised of a first reagent. The first cap may be configured to fit on an opening of the reaction vessel. In some cases, the test kit may further be comprised of: a liquid contained in the reaction vessel. The liquid may be configured to form a solution with the first reagent. In some cases, the test kit may further be comprised of: a lateral-flow assay strip. In some cases, the test kit may further be comprised of any one or any combination of: a swab, a heater, a mobile application configured to guide use of the test kit, a readout device, and a second cap comprised of a second reagent.

The foregoing and other aspects, embodiments, and features of the present technology can be more fully understood from the following description in conjunction with the accompanying drawings.

### BRIEF DESCRIPTION OF THE DRAWINGS

A skilled artisan will understand that the accompanying drawings are for illustration purposes only. It is to be understood that in some instances various aspects of the present technology may be shown exaggerated or enlarged to facilitate an understanding of the invention. In the drawings, like reference characters generally refer to like features, which may be functionally similar and/or structurally similar elements, throughout the various figures. The drawings are not necessarily to scale, as emphasis is instead placed on illustrating and teaching principles of the various aspects of the present technology. The drawings are not intended to limit the scope of the present teachings in any way.

FIGS. 1A to 1D show views of a releasable caged cap, according to some embodiments of the present technology.

FIGS. 2A to 2D show view of a blister cap, according to some embodiments of the present technology.

FIGS. 3A to 3F shows views of a caged cap, according to some embodiments of the present technology.

FIG. 4 shows a “chimney-type” detector for rapid diagnostic testing, according to some embodiments of the present technology.

FIGS. 5A to 5B show test kits for rapid diagnostic testing, according to some embodiments of the present technology.

### DETAILED DESCRIPTION

### 1. Introduction

Diagnostic test apparatuses and test methods may require one or more reagent(s) to be added during a test procedure. In some embodiments of the present technology described herein, diagnostic tests may be performed in a home or other non-clinical setting by a lay person (e.g., a person not trained in laboratory techniques). The lay person may even be the subject to be tested. Complicated procedures and/or complicated devices or tools for adding the one or more reagent(s) in precise amount(s) may increase the likelihood of an error and/or contamination occurring, which may decrease the likelihood of obtaining an accurate result.

The present disclosure provides a reagent carrier that enables a user (e.g., a lay person) to add a desired amount of a reagent to a test procedure without directly contacting or handling the reagent. For instance, there is no requirement for a finger, a tweezer, a spatula, a spoon, a pipette, or the like, to be used or operated by the user to add the reagent at an amount suitable for achieving an accurate test result.

In some embodiments of the present technology, the reagent carrier may be comprised of a cage confining a reagent (or multiple reagents). The cage may have an open structure that permits fluid to flow into the cage to interact with the reagent(s) but does not permit easy removal of the reagent(s) from the cage.

In some embodiments of the present technology, the reagent carrier may be comprised of a cage that releasably holds a reagent (or multiple reagents). The cage may have a deformable structure that a user may controllably deform to release the reagent(s) into, e.g., a reaction vessel, but without the user directly contacting or handling the reagent(s).

In some embodiments of the present technology, the reagent carrier may comprise a caged cap that includes a cap portion and a cage portion attached to the cap portion. As described herein, the cage portion may be structured to retain one or more reagent(s), and the cap portion may be structured to cover an opening of a reaction vessel (e.g., a reaction tube, a reaction chamber, etc.). As described herein, the reagent may be comprised of a lyophilized material solidified into a desired form (e.g., a pellet, a tablet, a bead, etc.) that fits in the cage, in some embodiments. An amount of the lyophilized material appropriate for a test procedure may be included in each solidified form of the lyophilized material. In some embodiments, the reagent may be comprised of particulates (e.g., powder) or a liquid surrounded by a dissolvable covering (e.g., a shell, a capsule, a gelcap, etc.) containing the particulates or the liquid therein.

The present disclosure further provides rapid diagnostic apparatuses, methods, and test kits that enable a lay person to perform diagnostic testing to detect one or more target nucleic acid sequence(s). The apparatuses may include any one or any combination of: test apparatuses (e.g., a “chimney” type test apparatus, an apparatus that utilizes blister packs, etc.); component(s) useable by or in the test apparatuses (e.g., a sample-collecting component such as a sample swab, etc.); device(s) used in or with the test apparatuses (e.g., heater(s), caged cap(s) and/or other reactant carrier(s), reaction tube(s) and/or other reaction vessel(s), etc.); reagent(s) (e.g., lysis reagent(s), nucleic-acid amplification reagent(s), CRISPR/Cas detection reagent(s), buffer(s), etc., any one or more of which may be provided in reagent carrier(s) and/or reaction vessel(s)); test component(s) used in rapid-diagnostic test procedures (e.g., lateral flow assay strip(s)); and reader device(s) used to read test results (e.g., sample readouts (e.g., photographs, illustrations, etc.) for a user to compare with actual test results to determine a presence or an absence of pathogen(s), application(s) installable on electronic devices to electronically read digital images of test results, etc.), according to some embodiments of the present technology. In some embodiments, the methods may include procedures for making or using any one or any combination of the test apparatuses, components; devices, test components, and reader devices mentioned above and/or described herein. In some embodiments, each test kit may be comprised of any combination of one or more of the test apparatuses, components, devices, test components, and reader devices mentioned above and/or described herein, and may include instructions for a lay person to use the various parts of the test kit in test procedures and/or to read a diagnostic result manually or with the aid of an application installed on an electronic device.

As noted above, the rapid diagnostic tests may involve test procedures for detecting one or more pathogen(s) in a sample obtained from a subject by detecting one or more target nucleic acid sequence(s) corresponding to the pathogen(s). Examples of the pathogen(s) that may be detected include SARS-CoV-2, an influenza A virus, an influenza B virus, to name a few. The rapid diagnostic tests, as described herein, may be performed in a point-of-care (POC) setting (e.g., a home, a school, and office, a library, etc.) without specialized equipment.

### 2. Reagent Carriers

### Releasable-Reactant Caged Cap

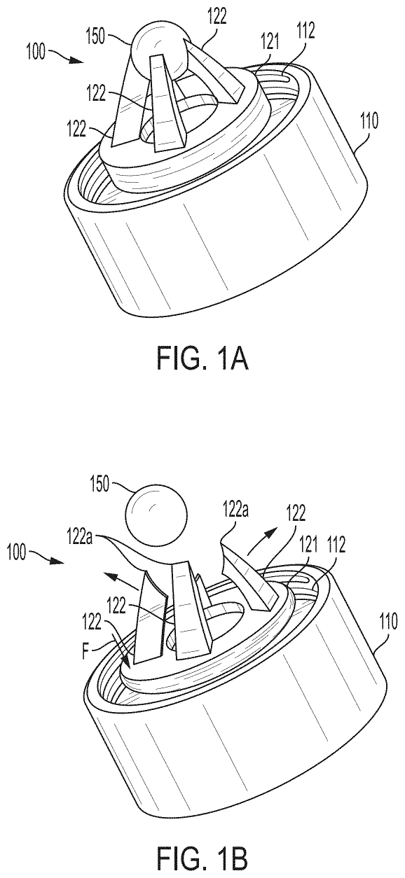

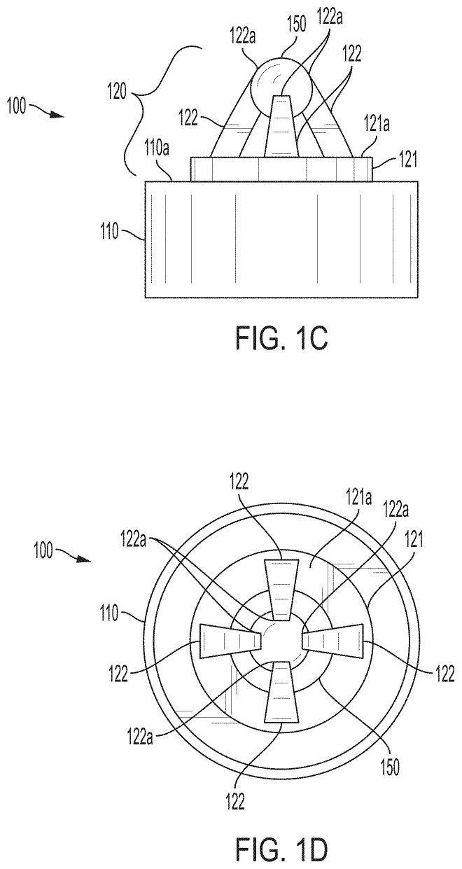

According to some embodiments of the present technology, a reagent carrier may be structured to retain a reagent using a cage structure. FIGS. 1A to 1D show an embodiment of such a cage structure in the form of a caged cap 100. FIGS. 1A and 1B show perspective views of the caged cap 100; and FIGS. 1C and 1D show elevational and top plan views of the caged cap 100, respectively.

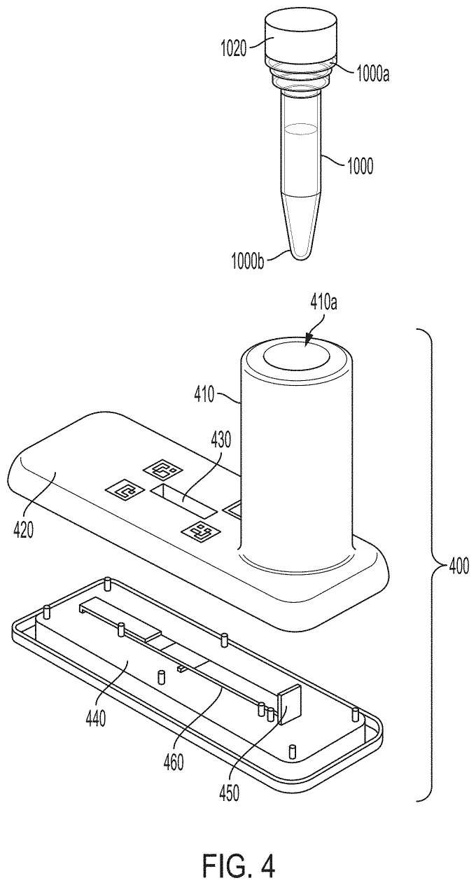

In some embodiments of the present technology, the caged cap 100 may be comprised of a cap base 110 supporting a retaining cage 120 configured to hold or confine a reagent 150 to the cap base 110, as shown in the perspective view of FIG. 1A. In some embodiments, the retaining cage 120 may be attached to the cap base 110 by an adhesive material that adheres a bottom surface of the retaining cage 120 to an interior bottom surface of the cap base 110. In some embodiments, a base portion of the retaining cage 120 may be press-fit into a trench or groove at an interior portion of the cap base 110 and may be prevented from separating from the cap base 110 by a wall of the trench or groove, as described below. In some embodiments, the cap base 110 may have a cylindrical interior wall on which a threaded structure 112 is formed, so that the cap base 110 may be screwed onto a complementary threaded structure on an outer surface of reaction vessel. For example, in some embodiments the reaction vessel may be a reaction tube 1000, such as that shown in FIG. 4.

In some embodiments of the present technology, the cap base 110 may be formed of a hard material (e.g., a hard plastic, a metal, a wood-based material, and the like.), and the retaining cage 120 may be formed of a resilient material, which may be a material that flexes under application of a force but returns to an equilibrium form when no force is applied (e.g., a synthetic rubber, a natural rubber, a silicone-based foam, and the like). The retaining cage 120 may be comprised of a retainer base 121 and a plurality of fingers 122 extending from the retainer base 121 such that tips 122a of the fingers 122 may be angled toward each other. In some embodiments, a top surface 121a of the retainer base 121 may be located external to the cap base 110 (e.g., above an upper edge 110a of the cap base 110), as depicted in the elevational side view of FIG. 1C. In some other embodiments, the top surface 121a of the retainer base 121 may be located internal to the cap base 110, such that the top surface 121a cannot be seen in an elevational side view of the caged cap 100.

According to some embodiments of the present technology, when the caged cap 100 is in a rest state before the reagent 150 is loaded, the tips 122a may touch each other or may be spaced apart but nearly touch each other, such that there is a common space between the tips 122a. The common space may have a dimension that is smaller than a dimension of the reagent 150. For example, the common space may have a maximum dimension (e.g., 0 or touching, 1 mm, 2 mm, etc.) that is smaller than a minimum dimension (e.g., 3 mm, 4 mm, etc.) of the reagent 150, i.e., the reagent 150 may be larger than the common space. When the retaining cage 120 is being loaded with the reagent 150, the resilient material forming the fingers 122 may flex outwards, away from each other, to accommodate the reagent 150 in the common space. For instance, during loading, an external force may be applied to spread apart the tips 122a of the fingers 122 to enlarge the common space to accommodate the reagent 150. After loading the reagent 150 into the common space, an internal restoring force in the resilient material may cause the tips 122a of the fingers 122 to try to return to their rest positions, thus imparting a holding force against the reagent 150 and causing the reagent 150 to be caged or held in place in the common space.

In some embodiments of the present technology, the resilient material forming the retaining cage 120 may enable the retaining cage 120 to flex and move when the caged cap 100 is placed on an opening of a reaction vessel and a force is applied by a user to attach the caged cap 100 to the reaction vessel. For example, the force may be applied by the user to twist the caged cap 100 to screw the caged cap 100 onto the reaction vessel. Engagement of the reaction vessel with the caged cap 100 may cause movement and/or deformation of the fingers 122 of the retaining cage 120 sufficient to cause separation of the tips 122a of the fingers, thus enabling the reagent 150 to be released into an internal portion of the reaction vessel. In some embodiments, the reagent 150 may be released into a fluid held in the internal portion of the reaction vessel.

In some embodiments of the present technology, the retaining cage 120 may be structured such that a surface of the retainer base 121 may come into contact with an edge or lip of the reaction vessel when the caged cap 100 is being attached to the reaction vessel, thus providing the necessary contact and release force F to cause movement and/or deformation of the fingers 122 to release the reagent 150 into the reaction vessel. Such movement is schematically depicted in FIG. 1B by arrows representing flexing or movement of the fingers 122 in response to the release force F caused by movement and/or contact associated with attachment of the caged cap 100 to the reaction vessel. Release of the reagent 150 into the internal portion of the reaction vessel may result from gravity.

According to some embodiments of the present technology, the caged cap 100 may be a friction-fit cap and may not have a threaded surface typical of a screw cap. In some embodiments, when the caged cap 100 is a friction-fit cap, a user may attach the caged cap 100 to a reaction vessel by first aligning the caged cap 100 on with an external edge of the reaction vessel and then applying a force to push the caged cap 100 and the reaction vessel together. As noted above, the retaining cage 120 may be structured such that a surface of the retainer base 121 may come into contact with an edge or lip of the reaction vessel when the caged cap 100 is being attached to the reaction vessel, thus providing the necessary contact and reagent-release force F to cause movement and/or deformation of the fingers 122 to release the reagent 150 into the internal portion of the reaction vessel.

In some embodiments of the present technology, the retaining cage 120 may be press-fit or snap-fit into a trench or groove formed in an interior portion of the cap base 110, without the need for an adhesive. The trench or groove of the cap base 110 may be formed of a wall that extends radially from an interior sidewall of the cap base 110. A dimension of an opening formed by the wall of the trench or groove (e.g., an inner diameter of the opening) may be smaller than a dimension of a lip portion of the retaining cage 120 intended to fit in the trench or groove. The resilient material forming the retaining cage 120 may enable the lip portion of the retaining cage 120 to flex and bend when force is applied during attachment of the retaining caged 120 to the cap base 110, such that the lip portion may snap into place in the trench or groove. Once the lip portion is seated in the trench or groove, the wall of the trench or groove of the cap base 110 may prevent the retaining cage 120 from separating from the cap base 110.

In some embodiments of the present technology, the reagent 150 may be a solid structure throughout (e.g., a pellet, a tablet, a bead, and the like) or may have a solid, dissolvable casing or shell holding a fluid and/or loose particles inside (e.g., a capsule, a gelcap, and the like). As described herein, the reagent 150 may include one or more time-release coatings configured to dissolve in fluid upon occurrence of certain time condition(s) and/or other condition(s) (e.g., heat, humidity, etc.).

In some embodiments of the present technology, the reagent 150 may be manufactured to include a predetermined dosage or amount of an active component suitable for a particular test procedure in which the caged cap 100 is used. Thus, in some embodiments, the reagent 150 may be specially formulated with desired amounts of desired chemicals. In some embodiments, the caged cap 100 may be color coded and/or may have indicia to indicate a type and/or a dosage of the reagent 150 held or retained by the caged cap 100. For example, a red caged cap may indicate a first reagent at a first dosage; a yellow caged cap may indicate a second reagent at a second dosage; a red and yellow striped caged cap may indicate a combination of first and second reagents at a third dosage; etc. Similarly, a caged cap bearing a number “1” may indicate a reagent to be added first in a test procedure, a caged cap bearing a number “2” may indicate a reagent to be added next in the test procedure, and so on.

Although FIGS. 1A to 1D show the fingers 122 and the reagent 150 to be located external to the cap base 110 (e.g., above an upper edge 110a of the cap base 110), in some embodiments of the present technology the fingers 122 and the reagent 150 may be located internal to the cap base 110, such that the reagent 150 cannot be seen in an elevational side view of the caged cap 100. An advantageous aspect of such embodiments is that it may be more difficult to dislodge the reagent 150 from the fingers 122 accidentally (e.g., by accidentally pressing an edge of a reaction tube on one or more of the fingers 122 before the cap base 110 is properly positioned relative to an opening of the reaction tube.

In some embodiments of the present technology, the retaining cage 120 of the caged cap 100 may be formed of a pliable elastomer that may deform to release the reagent 150 when the cap base 110 is attached to a reaction vessel. For example, the retaining cage 120 may be formed of a resilient elastomer that may deform to release the reagent 150 when the cap base 110 is attached to the reaction vessel. In some embodiments, the retaining cage 120 may be formed of a material comprised of any one or any combination of: a polyisoprene; a silicone rubber; an ethylene propylene diene monomer (EPDM); a styrene-butadiene copolymer; a urethane-based elastomer, a fluoroelastomer; and a thermoplastic rubber.

In some embodiments of the present technology, the caged cap 100 may be recyclable. After the reagent 150 is released from the retaining cage 120, the caged cap 100 may be cleaned (e.g., sterilized) and then reused to hold another reagent 150.

### Releasable-Reactant Blister-Type Cap

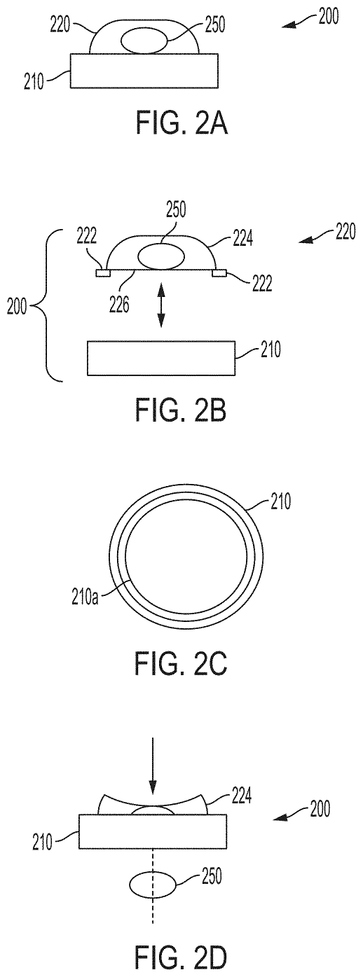

In various embodiments of the present technology, a reagent carrier may comprise a cap configured with blister technology. FIG. 2A schematically depicts a blister cap 200, according to some embodiments. The blister cap 200 may comprise a cap base 210 supporting a blister pack 220 configured to hold or confine a reagent 250 to the cap base 210, as shown in the schematic elevational view of FIG. 2A. The blister cap 200 is shown partially disassembled in the schematic elevational view of FIG. 2B. FIG. 2C schematically shows a plan view of a section of the cap base 210.

In some embodiments of the present technology, the blister pack 220 may be attached to the cap base 210 by an adhesive material that adheres a rim 222 of the blister pack 220 to an interior ledge 210a of the cap base 210. In some embodiments, the rim 222 of the blister pack 220 may be press-fit into a trench or groove at an interior portion of the cap base 210 and may be prevented from separating from the cap base 210 by a wall of the trench or groove. In some embodiments, the cap base 210 may have a cylindrical interior wall on which a threaded structure is formed, so that the cap base 210 may be screwed onto a complementary threaded structure on an outer surface of reaction vessel.

In some embodiments of the present technology, the blister pack 220 may be comprised of a cover 224 sealed to a frangible bottom 226, with the reagent 250 confined in a region between the cover 224 and the bottom 226. In some embodiments, the cover 224 may be formed of a malleable plastic and may be shaped as a button that may be pressed by a user when the reagent 250 is to be added during a test procedure. For example, the malleable plastic may be a clear high-density polyethylene, which may enable the user to see through the cover 224 and, e.g., confirm from a color and/or a shape of the reagent 250 that it is the correct material to be added. In some embodiments, the bottom 226 may be formed of a breakable layer (e.g., a metal foil). As schematically depicted in FIG. 2D, when the malleable plastic button of the cover 224 is pressed by the user (as represented by the arrow in FIG. 2D), a force exerted by the user against the cover 224 may push the reagent 250 through the breakable layer of the bottom 226, thus releasing the reagent 250 from the blister pack 220. In some embodiments, the bottom 226 may be formed of a film having a frangibility that causes the film to break when the cap base 210 is attached to a reaction vessel. For example, the frangible film may be comprised of any one or any combination of: a metal layer (e.g., a metal foil); a paper layer (e.g., tissue paper); and a polymer-based layer (e.g., a plastic film perforated for easy breakage). In some embodiments, the bottom 226 may be configured to break to release the reagent 250 during attachment of the cap base 210 to a reaction tube.

In some embodiments of the present technology, the reagent carrier 200 may have a pliable contact portion configured to come into contact with the reaction vessel before the cap base 210 is fully attached to the reaction vessel. For example, the contact portion may be comprised of a portion of the rim 222 of the blister pack 220. Contact forces produced by the reaction vessel on the contact portion may cause deformation of the contact portion (e.g., the rim 222). The deformation may be sufficient to cause breakage of the frangible film of the bottom 226, which may allow the reagent 250 to be released from the reagent carrier 200.

### Non-Releasable-Reactant Caged Cap

As an alternative to the caged cap 100, in which the reagent 150 may be released when the caged cap 100 is attached to the reaction vessel, in some embodiments of the present technology a reagent may remain caged and may dissolve in place without being released.

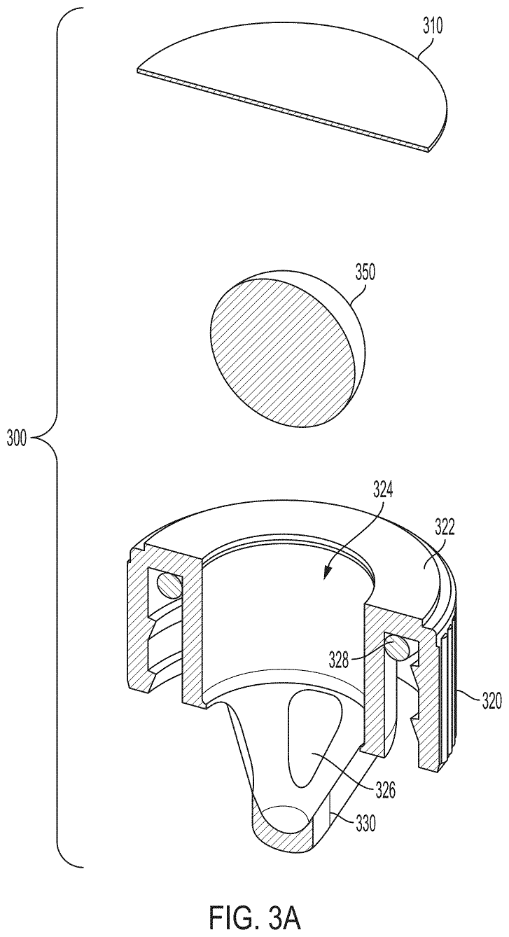

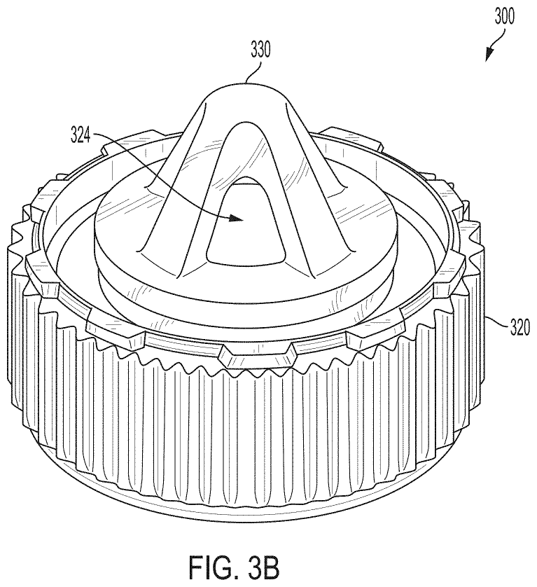

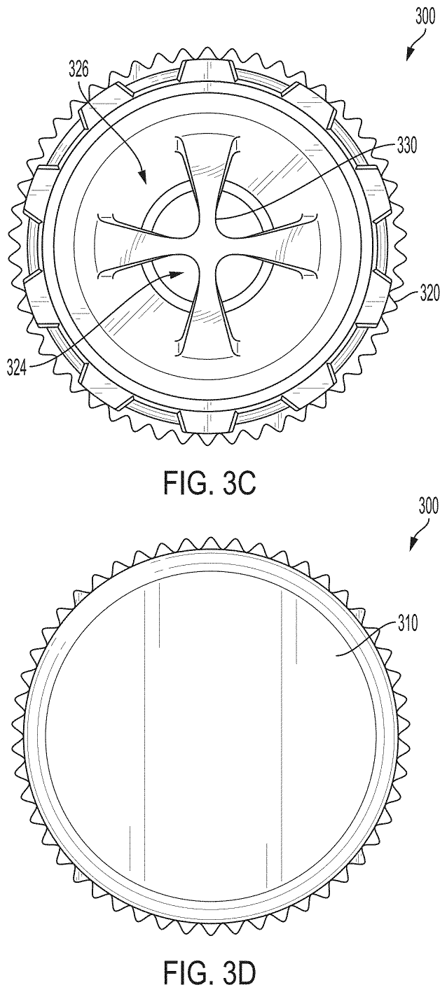

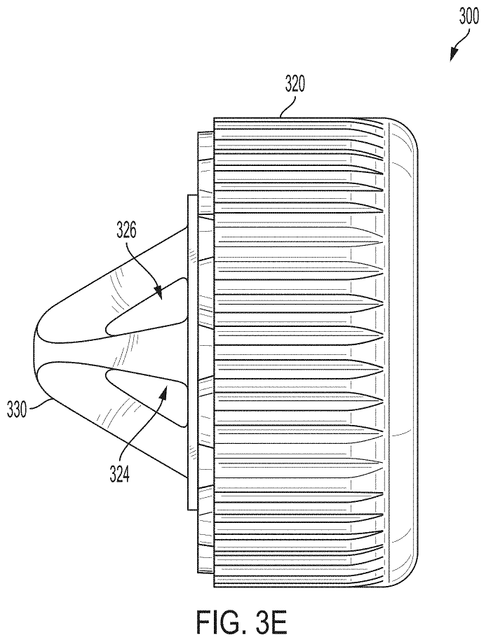

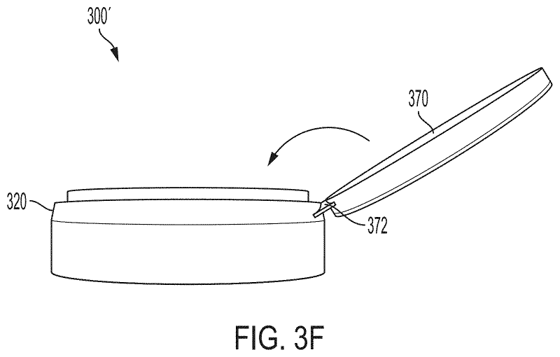

FIG. 3A shows a perspective sectional view of a caged cap 300 in a partially disassembled state, according to some embodiments of the present technology. FIGS. 3B to 3E show a perspective view, a bottom plan view, a top plan view, and a side elevational view, respectively, of the caged cap 300, according to some embodiments.

In some embodiments of the present technology, the caged cap 300 may include a cover 310 configured to be sealable to a surface 322 of a cap base 320, and a cage structure 330 integrated with the cap base 320. The cap base 320 may be structured to be mountable on a reaction tube (not shown). A reagent 350 may be held in a space 324 between the cage structure 330 and the cover 310. In some embodiments, the cage structure 330 may be integrally formed with the cap base 320 as a single structure. In some embodiments, the cage structure 330 and the cap base 320 may be formed separately and integrated together by known techniques (e.g., fusion bonding, adhesive bonding, bonding via a heat-sealable layer, etc.) after formation. The cage structure 330 may have a plurality of sections that may be interconnected to form an open structure that keeps the reagent 350 confined to the space 324 during transport and storage of the caged cap 300 (i.e., when the caged cap 300 is not being used in a test procedure). During a test procedure, the open structure of the cage structure 330 may enable fluid to flow to the reagent 350 while the reagent is confined into the region 324. For example, when the caged cap 300 is attached to a reaction vessel containing a fluid, and the reaction vessel is inverted such that the caged cap 300 is below the reaction vessel, the fluid in the reaction vessel may flow via gravity into the space 324 and may interact with and dissolve the reagent 350. A solution formed of the fluid and the reagent 350 may then flow away from the caged cap 300 when the reaction vessel is moved to an upright position with the caged cap 300 above the reaction vessel. A beneficial aspect of the caged cap 300 is that after the reagent is loaded in the space 324 the cover 310 may be sealed to the cap base 320. This may prevent the reagent 350 from being accidentally released or dislodged from the caged cap 300 before the reagent 350 is used in a test procedure.

In some embodiments of the present technology, the cover 310 may be formed of a layer of material or a laminate that contains a plurality of layers of different materials. In some embodiments, the cover 310 may be comprised of any one or any combination of: a metal (e.g., metal foil), a thermoplastic, an elastomer (natural or synthetic rubber), a thermoplastic elastomer, and/or any other suitable polymeric and/or metallic material. For example, the cover 310 may be formed of any combination of one or more of: polypropylene, polyethylene (e.g., LDPE, LLDPE, HDPE, MDPE, etc.), aluminum foil, copper foil, metal foil clad with a protective polymeric material, silicone rubber, etc. The cover 310 may be sealable to the surface 322 of the cap base 320 after the reagent 350 has been loaded into the space 324. In some embodiments, sealing of the cover 310 to the surface 322 of the cap base 320 may be accomplished by fusion bonding (e.g., heat melting, laser welding, induction welding, ultrasonic welding, etc.), by an adhesive (e.g., glue, epoxy, etc.), or by any other means of securing the cover 310 to the surface 322 of the cap base 320 to hold the reagent 350 in the caged cap 300 in a tamper-proof way. In some embodiments, a leak-tight seal is formed between the cover 310 and the surface 322 of the cap base 320.

FIG. 3F shows a side elevational view of a caged cap 300′ with an alternative cover structure to that of the caged cap 300, according to some embodiments of the present technology. Instead of the cover 310, the caged cap 300′ may comprise a flip-top lid 370 that may be attached to the cap base 320 by a hinge 372. A cage structure of the caged cap 300′ is not shown in FIG. 3F but may be similar to the cage structure 330 shown in FIGS. 3A, 3B, 3C, and 3E. As will be appreciated, the flip-top lid 370 may be used as a cover for the caged cap 100 discussed above. In FIG. 3F the flip-top lid 370 is in an opened position, which is the position at which the reagent 350 may be loaded into the space 324. When the flip-top lid 370 is in a closed position, the reagent 350 may be confined in the space 324. The curved arrow in FIG. 3F shows a trajectory that the flip-top lid 370 may take to go from the opened position to the closed position. In some embodiments, once the reagent 350 is loaded and the flip-top lid 370 is placed in the closed position, the flip-top lid 370 may be sealed closed (e.g., fusion bonding, adhesive, etc.) to prevent tampering with the reagent. The seal may be a leak-tight seal impervious to fluid leakage.

As noted above, the caged cap 300 does not release the reagent 350 but instead enables the reagent 350 to dissolve in place in the space 324, according to some embodiments of the present technology. That is, as discussed above, after the caged cap 300 is mounted on a reaction vessel, fluid may enter the space 324 via openings 326 in the cage structure 330, and contact between the fluid and the reagent 350 may dissolve the reagent 350. For example, a user may invert the reaction vessel (i.e., turn the reaction vessel upside down) or may rigorously shake the reaction vessel so that the fluid may enter the space 324 via the openings 326 to contact and dissolve the reagent 350. In these embodiments, the cage structure 330 need not be formed of a resilient material that deforms during attachment of the caged cap 300 to a reaction vessel (unlike the caged cap 100), but instead may be formed of a rigid material (e.g., hard plastic). For example, the cap base 320, the flip-top lid 370, and the cage structure 330 may be formed of molded plastic via a single molding operation. Non-limiting examples of plastics that may be used to form the caged cap 300, 300′ include polypropylene, polyethylene, and polyolefin. As will be appreciated, other moldable thermoplastics that set into a hard plastic may be used.

In some embodiments of the present technology, when the caged cap 300, 300′ is mounted on a reaction vessel, a hard seal may be formed between the reaction vessel and the caged cap 300, 300′, which may prevent spillage or leakage of fluid when the reaction vessel is inverted. Optionally, a leak-tight gasket 328 (e.g., a rubber o-ring) may be included in the cap base 320 to provide a fluid-tight seal when the caged cap 300, 300′ is mounted on a reaction vessel.

### Methods of Using a Caged Cap or a Blister-Type Cap

The reagent carriers described above may be used in a test procedure in different ways. According to some embodiments of the present technology, a method of using the caged cap 100 may be comprised of: placing an internal side of the cap base 110 on an opening of a reaction vessel (e.g., a reaction tube); and attaching the cap base 110 to the reaction vessel such that the retaining cage 120 attached to the cap base 110 is caused to release the reagent 150 into an internal environment of the reaction vessel. In some embodiments, the attaching of the cap base 110 may include screwing the cap base 110 onto the reaction vessel by mating a threaded surface of the cap base 110 with a corresponding threaded surface of the reaction vessel. In some embodiments, the attaching of the cap base 110 may cause the retaining cage 120 to deform to release the reagent 150. In some embodiments, the attaching may cause at least one finger 122 of the retaining cage 120 to deform to release the reagent. In some embodiments, a solution may be formed by interaction of the reagent 150 and fluid in the reaction vessel and/or fluid added to the reaction vessel.

According to some embodiments of the present technology, a method of using the blister cap 200 may be comprised of: placing an internal side of the cap base 210 on an opening of a reaction vessel (e.g., a reaction tube); and attaching the cap base 210 to the reaction vessel such that the frangible bottom 226 of the blister pack 220 is caused to break to release the reagent 250 into an internal environment of the reaction vessel. The attaching may be comprised of deforming the rim 222 of the blister pack 220 by contacting the rim 222 to an end or surface of the reaction vessel, with the deforming of the rim 222 causing the bottom 226 to break. In some embodiments, a solution may be formed by interaction of the reagent 250 and fluid in the reaction vessel and/or fluid added to the reaction vessel.

According to some embodiments of the present technology, a method of using the blister cap 200 may be comprised of: placing an internal side of the cap base 210 on an opening of a reaction vessel (e.g., a reaction tube); attaching the cap base 210 to the reaction vessel; and applying a force to the malleable cover 224 to push the reagent 250 through the bottom 226 and release the reagent 250 into an internal environment of the reaction vessel. The cover 224 may be formed in a shape of a button or blister bubble, and the applying of the force may be comprised of a user using a finger or other object to push the button or bubble. In some embodiments, a solution may be formed by interaction of the reagent 250 and fluid in the reaction vessel and/or fluid added to the reaction vessel.

According to some embodiments of the present technology, a method of using the caged cap 300 may be comprised of: placing an internal side of the cap base 320 on an opening of a reaction vessel (e.g., a reaction tube) containing a fluid; attaching the cap base 320 to the reaction vessel; and inverting the reaction vessel with the caged cap 300 attached such that the caged cap 300 is below the reaction tube. The method may further be comprised of permitting the fluid in the reaction tube to into the space 324 and to interact with and dissolve the reagent 350 the space 324. The solution formed of the fluid and the reagent 350 flow away from the caged cap 300 when the reaction tube is moved to an upright position with the caged cap 300 above the reaction tube, via the force of gravity.

### Shelf-Stability

The shelf-stability and thermal stability of reagents, liquids (e.g., buffers), and other chemical materials used in the diagnostic testing described herein, as well as the stability of the equipment that may be used to perform the diagnostic testing (for example, test apparatuses (e.g., a “chimney” type test apparatus, an apparatus that utilizes blister packs, etc.); component(s) useable by or in the test apparatuses (e.g., a sample-collecting component such as a sample swab, etc.); device(s) used in or with the test apparatuses (e.g., heater(s), reactant carrier(s), reaction tube(s) and/or other reaction vessel(s), etc.); reagent(s) (e.g., lysis reagent(s), nucleic-acid amplification reagent(s), CRISPR/Cas detection reagent(s), buffer(s), etc., any one or more of which may be provided in reagent carrier(s) and/or reaction vessel(s)); test component(s) used in rapid-diagnostic test procedures (e.g., lateral flow assay strip(s)); and reader device(s) used to read test results (e.g., sample readouts (e.g., photographs, illustrations, etc.) for a user to compare with actual test results to determine a presence or an absence of pathogen(s), application(s) installable on electronic devices to electronically read digital images of test results, etc.)) enable the equipment and the reagents, buffers, and other chemical materials to be transported and/or stored without the need for special transportation and/or storage considerations (e.g., a thermally controlled environment, a barometrically controlled environment, etc.).

In some embodiments of the present technology, the reagent 150, 250, 350 held by the reagent carrier 100, 200, 300 may be comprised of one or more of: a pellet, a tablet, a capsule, and a gelcap. In some embodiments, the reagent 150, 250, 350 may be stable under ambient conditions (e.g., room temperatures, atmospheric pressures, less than about 60% humidity). For example, the reagent 150, 250, 350 may be stable at temperatures in a range of about −15° C. to about 50° C., or about −10° C. to about 40° C., or about 10° C. to about 35° C. In some embodiments, the reagent 150, 250, 350 may be coated with at least one time-release coating. In some embodiments, the reagent 150, 250, 350 may be a gelcap comprised of: a dissolvable solid exterior layer formed of a gelatin material, and a liquid or particulates contained in the solid exterior layer. In some embodiments, the reagent 150, 250, 350 may be a capsule comprised of: a dissolvable exterior layer, and a liquid or particulates contained in the solid exterior layer.

According to some embodiments of the present technology, the reagent carrier 100, 200, 300, which may include reagent(s) therein, may be transported by a method comprising: packaging the reagent carrier to prevent shock to the reagent carrier; transporting the packaged reagent carrier to a destination at an ambient temperature in a range of about −15° C. to about 50° C. (e.g., about −10° C. to about 40° C., about 10° C. to about 35° C.) and at an ambient pressure in a range of about 0.8 atm to about 1.2 atm (e.g., about 0.9 atm to about 1.1 atm). In some embodiments, the packaging of the reagent carrier may comprise surrounding the reagent carrier with a shock absorber such that accidental dropping of the packaged reagent carrier from a height of about 10 feet may not cause the reagent to dislodge from the confined position. In some embodiments, the shock absorber may comprise any one or any combination of: a plastic enclosure (e.g., a plastic shell preformed with one or more regions that accommodate the reagent carrier in a suspended state in which the shell absorbs shock and vibrations instead of the reagent carrier), a paper-based enclosure (e.g., cardboard formed or arranged to protect the reagent carrier from shock), bubble wrap material, styrofoam (e.g., peanuts and/or a shell preformed to accommodate the reagent carrier and absorb shock and vibrations), etc. In some embodiments, the packaging of the reagent carrier may include packaging diagnostic testing equipment, such as those mentioned above, to be used with the reagent carrier, i.e., the reagent carrier and the diagnostic testing equipment may be packaged together. In some embodiments, a plurality of reagent carriers may be packaged together, without or without the diagnostic testing equipment.

### 3. Reagents

In some embodiments of the present technology, diagnostic test apparatuses and test methods may comprise and/or utilize one or more reagent(s) (e.g., lysis reagent(s), nucleic acid amplification reagent(s), CRISPR/Cas detection reagent(s), and the like). In some instances, reagent(s) may be contained within a diagnostic test apparatus (e.g., in a reaction chamber of the diagnostic test apparatus). In some embodiments, reagent(s) may be provided separately (e.g., in caged cap(s), blister cap(s), reaction tube(s), etc.). For example, a diagnostic test apparatus may comprise one or more caged cap(s) comprising lysing reagent(s) and/or amplification reagent(s). Lysis technology and amplification technology are discussed below.

In some embodiments of the present technology, at least one (and, in some instances, each) of the reagent(s) may be in liquid form (e.g., in solution). In some embodiments, at least one (and, in some instances, each) of the reagent(s) may be in solid form (e.g., lyophilized, dried, crystallized, air jetted, and the like).

### Lysing Reagents

In some embodiments of the present technology, the reagent(s) may be comprised of one or more lysis reagent(s). A lysis reagent may refer generally to a reagent that promotes cell lysis either alone or in combination with one or more other reagent(s) and/or one or more condition(s) (e.g., heating). In some embodiments, the lysis reagent(s) may be comprised of one or more enzyme(s). Non-limiting examples of suitable enzymes may include lysozyme, lysostaphin, zymolase, cellulose, protease, and glycanase. In some embodiments, the lysis reagent(s) may be comprised of one or more detergent(s). Non-limiting examples of suitable detergents may include sodium dodecyl sulphate (SDS), Tween (e.g., Tween 20, Tween 80), 3-[(3-cholamidopropyl)dimethylammonio]-1-propanesulfonate (CHAPS), 3-[(3-cholamidopropyl)dimethylammonio]-2-hydroxy-1-propanesulfonate (CHAPSO), Triton X-100, and NP-40.

In some embodiments of the present technology, the lysis reagent(s) may comprise an RNase inhibitor (e.g., a murine RNase inhibitor). In some embodiments, the RNase inhibitor concentration is at least 0.1 U/μL, at least 1.0 U/μL, or at least 2.0 U/μL. In certain embodiments, the RNase inhibitor concentration is in a range from 0.1 U/μL to 0.5 U/μL, 0.1 U/μL to 1.5 U/μL, or 1.0 U/μL to 2.0 U/μL. In some embodiments, the lysis reagent(s) may comprise Tween (e.g., Tween 20, Tween 80).

### Contamination-Prevention Reagents

In some embodiments of the present technology, the reagent(s) may be comprise of at least one reagent to reduce or eliminate potential carryover contamination from prior tests (e.g., prior tests conducted with a common apparatus and/or in a same area). In some embodiments, the reagent(s) may be comprised of thermolabile uracil DNA glycosylase (UDG). In some embodiments, UDG may prevent carryover contamination from prior tests by degrading products that have already been amplified (i.e., amplicons) while leaving unamplified samples untouched and ready for amplification. In some embodiments, a concentration of UDG may be at least 0.01 U/μL, at least 0.03 U/μL, or at least 0.05 U/μL. In certain embodiments, the concentration of UDG may be in a range from 0.01 U/μL to 0.02 U/μL or 0.01 U/μL to 0.04 U/μL.

### Reverse Transcription Reagents

In some embodiments of the present technology, the reagent(s) may comprise one or more reverse transcription reagent(s). In some cases, a target pathogen may have RNA as its genetic material. In certain instances, for example, a target pathogen may be an RNA virus (e.g., a coronavirus, an influenza virus). In some such cases, the target pathogen's RNA may need to be reverse transcribed to DNA prior to amplification. In some embodiments, the reverse transcription reagent(s) may facilitate such reverse transcription. In some embodiments, the reverse transcription reagent(s) may be comprised of a reverse transcriptase, a DNA-dependent polymerase, and/or a ribonuclease (RNase). A reverse transcriptase may refer generally to an enzyme that transcribes RNA to complementary DNA (cDNA) by polymerizing deoxyribonucleotide triphosphates (dNTPs). An RNase may refer generally to an enzyme that catalyzes the degradation of RNA. In some embodiments, an RNase may be used to digest RNA from an RNA-DNA hybrid.

### Nucleic-Acid Amplification Reagents

In some embodiments of the present technology, the reagent(s) may comprise one or more nucleic-acid amplification reagent(s). A nucleic-acid amplification reagent may refer generally to a reagent that facilitates a nucleic-acid amplification method. In some embodiments, the nucleic-acid amplification method may be an isothermal nucleic-acid amplification method. In some cases, the isothermal nucleic-acid amplification method, unlike PCR-based methods, may avoid use of expensive, bulky laboratory equipment for precise thermal cycling. Non-limiting examples of suitable isothermal nucleic-acid amplification methods may include loop-mediated isothermal amplification (LAMP), recombinase polymerase amplification (RPA), nicking enzyme amplification reaction (NEAR), thermophilic helicase dependent amplification (tHDA), nucleic acid sequence-based amplification (NASBA), strand displacement amplification (SDA), isothermal multiple displacement amplification (IMDA), rolling circle amplification (RCA), transcription mediated amplification (TMA), signal mediated amplification of RNA technology (SMART), single primer isothermal amplification (SPIA), circular helicase-dependent amplification (cHDA), whole genome amplification (WGA), and CRISPR-related amplification, such as CRISPR-Cas9-triggered nicking endonuclease-mediated strand displacement amplification (CRISDA). In some embodiments, the nucleic-acid amplification reagent(s) may comprise LAMP reagents, RPA reagents, or NEAR reagents. Isothermal nucleic-acid amplification methods are discussed in more detail below.

### Reagent Stability Enhancers

In some embodiments of the present technology, the reagent(s) may comprise one or more additive(s) that may enhance reagent stability (e.g., protein stability). Non-limiting examples of suitable additives may include trehalose, polyethylene glycol (PEG), polyvinyl alcohol (PVA), and glycerol.

### Buffers

In some embodiments of the present technology, the reagent(s) may comprise one or more reaction buffer(s). Non-limiting examples of suitable buffers may include phosphate-buffered saline (PBS) and Tris. In some embodiments, the buffer(s) may be buffer fluid(s). In some embodiments, the buffer(s) may have a relatively neutral pH. In some embodiments, the one or more buffer(s) may have a pH in a range from 5.0 to 7.0, 6.0 to 8.0, 7.0 to 9.0, or 8.0 to 9.0. In some embodiments of the present technology, the buffer(s) may comprise one or more salt(s). Non-limiting examples of suitable salts may include magnesium acetate tetrahydrate, potassium acetate, and potassium chloride. In some embodiments, the buffer(s) may comprise Tween (e.g., Tween 20, Tween 80). In some embodiments, the buffer(s) may comprise an RNase inhibitor. In certain instances, Tween and/or an RNase inhibitor may facilitate cell lysis. In a particular, non-limiting embodiment of the present technology, the buffer(s) may comprise 25 mM Tris buffer, 5% (w/v) poly(ethylene glycol) 35,000 kDa, 14 mM magnesium acetate tetrahydrate, 100 mM potassium acetate, and greater than 85% volume nuclease free water.

### 4. Exemplary Diagnostic Test

Reagent carriers according to the present technology disclosed herein may be used with any test or any test component. For example, the reagent carriers may be used to perform a diagnostic test to detect one or more pathogen(s) of interest. Described below is one non-limiting example of a diagnostic test that may utilize one or more reagent carrier(s) of the present technology. Components of an exemplary diagnostic test apparatus may comprise, for example, reaction vessels (e.g., reaction vials, reaction tubes, and the like, which may be used to carry out a reaction involving a sample and/or a reagent), reagent carriers (e.g., caged caps, blister caps, ampoules, blister packs, vials, containers, and the like, which may carry one or more reagents to be used in test procedures performed by the diagnostic test apparatus), and/or sample collectors (e.g., swabs, cell scrapers, tongue depressors, and the like, which may be used to obtain samples from subjects to be tested). Such components also may comprise a detection component (e.g., a lateral-flow assay strip).

Unlike prior-art diagnostic testing schemes, the exemplary diagnostic test may not require knowledge of even basic laboratory techniques (e.g., pipetting) or chemistry or biology. Additionally, unlike diagnostic testing schemes that require bulky equipment, a test apparatus and its components for performing the diagnostic test may be easily transported and/or easily stored in homes, businesses, schools, and other non-laboratory settings. In some embodiments of the present technology, storage of the test apparatus and its components, including reagent carrier(s) used in the diagnostic test, may be at ambient environmental conditions (e.g., at room temperature and atmospheric pressure).

a. Test Apparatus

In some embodiments of the technology described herein, the exemplary diagnostic test may be carried out using a “chimney-type” detection apparatus. In certain embodiments, the “chimney-type” detection apparatus may comprise a chimney configured to receive a reaction tube. In certain embodiments, the “chimney-type” detection apparatus may comprise a puncturing component configured to puncture the reaction tube. The puncturing component may comprise one or more blades, needles, and/or one or more other elements or devices capable of puncturing material forming the reaction tube. In certain embodiments, the “chimney-type” detection apparatus may comprise a lateral-flow assay strip. The lateral flow assay strip may comprise one or more test line(s) configured to detect one or more target nucleic-acid sequence(s) corresponding to one or more pathogen(s). In some embodiments, the lateral-flow assay strip may further comprise one or more control line(s).

A “chimney-type” detector 400 is shown in a partially disassembled state in FIG. 4, according to the present technology. The “chimney-type” detector 400 may be comprised of a chimney 410, a front panel 420 comprising an opening 430, and a back panel 440 comprising a puncturing protrusion 450 and a lateral-flow assay strip 460.

In some embodiments of the present technology, the chimney 410 may be comprised of an opening 410a configured to fit a reaction tube 1000 therein. The reaction tube 1000 may contain fluidic contents therein (e.g., a sample solution), and may be inserted into the opening 410a of the chimney 410. In some embodiments, the reaction tube 1000 may comprise a cap 1020 (e.g., a screw-top cap, a hinged cap, a friction-fit cap, and the like) covering an open top end 1000a and a sealed bottom end 1000b (e.g., a tapered end, a flat end, or a rounded end) opposite the top end 1000a. In some embodiments, the cap 1020 may be a reagent carrier, such as any of the reagent carriers described above (e.g., the caged cap 100, the blister cap 200, or the caged cap 300). In some embodiments, the bottom end 1000b of the reaction tube 1000 may be an insertion end and may enter first into the opening 410a of the chimney 410 during insertion of the reaction tube 1000 into the opening 410a of the chimney 410. When the bottom end 1000a is the insertion end, the reaction tube 1000 may be inserted into the chimney 410 prior to attachment of the cap 1020 onto the reaction tube 1000. In some embodiments, the reaction tube 1000 may be inverted such that the cap 1020 on the reaction tube 1000 may be the insertion end and may inserted into the opening 410a of the chimney 410 of the reaction tube 1000 first.

In some embodiments of the present technology, the opening 410a of the chimney 410 may be sized with suitable dimensions to receive the reaction tube 1000. For example, the opening 410a may be a cylindrical cavity configured to accommodate a tubular shape of the reaction tube 1000.

According to some embodiments of the present technology, prior to locking or snapping the reaction tube 1000 in place, the cap 1020 may be replaced with a reagent carrier (e.g., the caged cap 100, the blister cap 200, the caged cap 300). In some embodiments, if the reagent carrier is the caged cap 100, attachment of the caged cap 100 onto the open end 1000a of the reaction tube 1000 may cause the reagent 150 to be released into the fluidic contents in the reaction tube 1000, as described above. The reagent 150 may then be dissolved by the fluid contents. In some embodiments, if the reagent carrier is the blister cap 200, attachment of the blister cap 200 onto the open end 1000a of the reaction tube 1000 may cause the reagent 250 to be released from the blister pack 220 into the fluidic contents in the reaction tube 1000, as described above. In some cases, the reagent 250 may be released by a user pushing on the cover 224 of the blister pack 220 to cause the reagent 250 to be pushed through the frangible bottom 226 of the blister pack 220. The reagent 250 may then be dissolved by the fluid contents. In some embodiments, if the reagent carrier is the caged cap 300, attachment of the caged cap 300 onto the open end 1000a of the reaction tube 1000 and then inverting the reaction tube 1000 (i.e., turning the reaction tube 1000 upside down) may cause the fluid contents to flow toward the caged cap 300 and through the openings 326 in the cage structure 330 to dissolve the reagent 350, as described above.

In some embodiments of the present technology, the reaction tube 1000 may be punctured by the puncturing protrusion 450. As a result of puncturing, at least a portion of the fluidic contents may flow out of the reaction tube 1000 and may be deposited on a first sub-region (e.g., a sample pad) of the lateral-flow assay strip 460. In some embodiments, at least a portion of the fluidic contents of the reaction tube 1000 may flow or be transported through the lateral-flow assay strip 460 (e.g., via capillary action). In some embodiments, at least a portion of the fluidic contents of the reaction tube 1000 may flow through a second sub-region (e.g., a particle conjugate pad) of the lateral-flow assay strip 460. The second sub-region may be comprised of a plurality of labeled particles. In some embodiments, the fluidic contents of the reaction tube 1000 may be comprised of one or more amplified nucleic acid(s) (e.g., amplicon(s)). Flow of at least a portion of the fluidic-contents through the second sub-region (e.g., particle conjugate pad) of the lateral-flow assay strip 460 may result in one or more labeled amplicon(s). In some embodiments, at least a portion of the fluidic contents of the reaction tube 1000, which may be comprised of one or more labeled amplicon(s), may flow through a third sub-region (e.g., a test pad) comprised of one or more test line(s) that each may be comprised of one or more capture reagent(s) (e.g., immobilized antibody(ies)) configured to detect one or more target nucleic acid sequence(s). In some embodiments, formation (or lack of formation) of one or more opaque line(s) at the one or more test line(s) may indicate a presence of one or more target nucleic acid sequence(s). Alternatively, in some embodiments, formation (or lack of formation) of one or more opaque line(s) at the one or more test line(s) may indicate an absence of one or more target nucleic acid sequence(s). In some embodiments, the one or more opaque line(s), if present, may be visible through the opening 430 of the front panel 420.

b. Test Kit

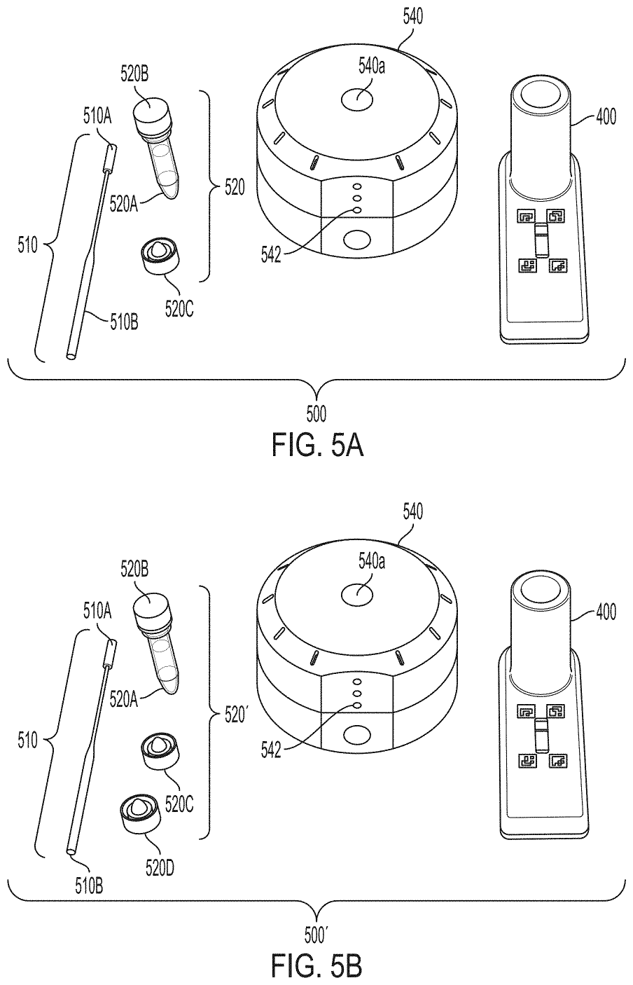

FIGS. 5A and 5B show diagnostic test kits 500, 500′ that comprise the “chimney-type” detector 400, according to some embodiments of the present technology. As shown in FIG. 5A, the diagnostic test kit 500 may comprise a sample-collecting component 510, a reaction vessel 520, the detector 400, and a heater 540, according to some embodiments. The sample-collecting component 510 may be a swab comprised of a swab element 510A and a stem element 510B. In some embodiments, the reaction vessel 520 may be comprise of a vial 520A, a first cap 520B, and a second cap 520C. The first cap 520B and/or the second cap 520C may be screw-top caps or any other type(s) of removable caps. In some embodiments, the first cap 520B and/or the second cap 520C may be airtight caps (e.g., they may each fit on the vial 520A without any gap and thus may seal the vial 520A). In some embodiments, the second cap 520C may be a reagent carrier (e.g., the caged cap 100, the blister cap 200, the caged cap 300) and may be comprised one or more reagent(s) (e.g., lysis reagent(s), nucleic acid amplification reagent(s), CRISPR/Cas detection reagent(s), and the like). In some embodiments, the reaction vessel 520 may comprise fluidic contents held in the vial 520A. In some embodiments, the fluidic contents of the reaction vessel 520 may be comprised of a reaction buffer. For example, the reaction buffer may comprise one or more buffers (e.g., phosphate-buffered saline (PBS), Tris, and the like). In some embodiments, the reaction buffer may be comprised of one or more salt(s). The vial 520A of the reaction vessel 520 may be sized to contain or hold any suitable volume of the reaction buffer.

In operation, according to some embodiments of the present technology, a user may collect a sample using the sample-collecting component 510. In some embodiments, the user may insert the swab element 510A into a nasal or oral cavity of a subject (e.g., the user, a friend or family member of the user, or any other human or animal subject). The first cap 520B may be removed from the vial 520A (e.g., either before or after collection of the sample), thereby exposing the fluidic contents held in the vial 520A, and, with the sample collected on the swab element 510A, the swab element 510A may be inserted into the vial 520A to contact the fluidic contents therein. In some embodiments, the user may stir or agitate the swab element 510A in the fluidic contents of the tube 520A for a period of time (e.g., at least 10 seconds, at least 20 seconds, at least 30 seconds, etc.). In some embodiments, the swab element 510A may be removed from the vial 520A after stirring or agitation. In some embodiments, the stem element 510B may be broken off and removed, such that the swab element 510A may remain in the fluid contents of the vial 520A.

In some embodiments of the present technology, after the swab element 510A and/or the stem element 510B is removed from the vial 520A, a cap may be placed on the vial 520A. In some embodiments, the second cap 520C may be placed on the vial 520A. In some embodiments, the vial 520A and/or the second cap 520C may comprise one or more reagent(s) (e.g., lysis reagents, nucleic acid amplification reagents, CRISPR/Cas detection reagents, and the like). In some embodiments, the second cap 520C may be a reagent carrier (e.g., the caged cap 100, the blister cap 200, the caged cap 300) and may be comprised of one or more reagent(s). In some instances, the one or more reagent(s) may be in solid form (e.g., lyophilized, dried, crystallized, air jetted, etc.). In some embodiments, the one or more reagent(s) may be in the form of one or more tablet(s) and/or pellet(s) and/or bead(s). In some embodiments, the one or more reagent(s) may have or more coating(s) (e.g., dissolvable coating(s) of a time release material). In some embodiments, the one or more reagent(s) may be in the form of one or more capsule(s). For example, each capsule may be comprised of a dissolvable shell holding particulates (e.g., powders) inside. In some instances, the one or more reagent(s) may be in liquid form. In certain cases, the one or more reagent(s) may be in the form of one or more gelcap(s). For example, each gelcap may be comprised of a dissolvable gelatin-based solid shell or capsule containing one or more liquid reagent(s) inside.

If the second cap 520C is a reagent carrier (e.g., the caged cap 100, the blister cap 200, the caged cap 300), the one or more reagent(s) therein may be released into the vial 520A by any suitable mechanism. In some embodiments in which the second cap 520C is the caged cap 300, the one or more reagent(s) may be released into the vial 520A in solution by inverting (and, in some cases, repeatedly inverting) the reaction vessel 520. In some embodiments in which the second cap 520C is the blister cap 200, the frangible bottom 226 may be broken by attaching (e.g., twisting, screwing, pushing) the second cap 520C onto the vial 520A and/or by a user pushing on the cover 224, to release the one or more reagent(s). In some embodiments in which the second cap 520C is the caged cap 100, the reagent(s) may be released by attaching (e.g., twisting, screwing, pushing) the second cap 520C onto the vial 520A.

In some embodiments of the present technology, heating may be required to promote a reaction in the reaction vessel 520. In some embodiments, the heater 540 may be configured to heat the reaction vessel 520 at one or more temperatures (e.g., at least 37° C., at least 65° C., etc.) for one or more periods of time. In some embodiments, heating of the reaction vessel 520 according to a first heating protocol (e.g., a first set of temperature(s) and time period(s)) may facilitate lysis of cells within a collected sample provided to the fluidic contents in the reaction vessel 520. In some embodiments, heating of the reaction vessel 520 according to a second heating protocol (e.g., a second set of temperature(s) and time period(s)) may facilitate amplification of one or more target nucleic acid(s) (if present within the collected sample). In some embodiments, the heater 540 may comprise an indicator 542 (e.g., a visual indicator) for indicating that a heating protocol is occurring. The indicator 542 may indicate to a user when the reaction vessel 520 should be removed from the heater 540. For example, the indicator 542 may be a set of different-colored LED lights in which each color may represent a stage of the heating protocol.

Following heating, the reaction vessel 520 may be inserted into the detector 400. As described above, upon insertion the reaction vessel 520 may be punctured by the puncturing protrusion 450 (e.g., a blade, a needle, and the like). In some embodiments of the present technology, at least a portion of the fluidic contents of reaction vessel 520 may be deposited onto a portion of the lateral-flow assay strip 460, as described above. The fluidic contents of the reaction vessel 520 may flow through the lateral-flow assay strip (e.g., via wicking or capillary action), and the presence or absence of one or more target nucleic acid sequence(s) may be indicated on an indicator portion of the lateral-flow assay strip 460 (e.g., by the formation of one or more visible line(s) on a test pad of the lateral-flow assay strip 460). In some embodiments, the indicator portion of the lateral-flow assay strip 460 may be visible through the opening 430 of the front panel 420. A user may obtain test results by comparing, for example, a graphical pattern (e.g., test lines, which may appear with or without control lines) on the lateral-flow assay strip 460 to illustrated examples of graphical patterns provided with the test kit 500 and/or via a website link provided with the test kit 500. In some embodiments, software (e.g., a mobile application) may be used to read, analyze, and/or report results to the user and/or to e.g., a technical professional. For example, the graphical pattern on the lateral-flow assay strip 460 may be read by machine-vision technology via an electronic image or photograph of the indicator portion of the lateral-flow assay strip 460 uploaded to a website or a mobile application.

In some embodiments of the present technology, a reaction vessel may be used with multiple different reagent carriers carrying reagents for different test procedures of a diagnostic test. As shown in FIG. 5B, the diagnostic test kit 500′ is the same as the diagnostic test kit 500 except that the diagnostic test kit 500′ includes a reaction vessel 520′ comprised of a third cap 520D. In some embodiments, the second cap 520C and the third cap 520D may be reagent carriers and may each comprise one or more reagent(s). In some cases, the second cap 520C may contain a first set of reagent(s) (e.g., lysis reagent(s)), and the third cap 520D may comprise a second set of reagent(s) (e.g., nucleic acid amplification reagent(s)). In some cases, the second and third caps 520C, 520D may have different colors to indicate that they contain different reagents. Other aspects of the diagnostic test kit 500′ are the same as those of the diagnostic test kit 500 and therefore will not be repeated.

In some embodiments of the present technology, the sample-collecting component 510 may be a breakable swab in which the swab element 510A and the stem element 510B may be separatable from each other. As will be appreciated, a breakable swab may enable the swab element 510A to remain in, e.g., a small testing chamber during a test procedure without requiring the testing chamber to be large enough to also accommodate the stem element 510B.

c. Reaction Vessel

Reaction vessels (e.g., the reaction vessel 520) may be formed from any suitable material and may have any suitable shape. In some embodiments of the present technology, a reaction vessel may be formed from a polymer. Non-limiting examples of suitable polymers may include polypropylene (PP), polytetrafluoroethylene (PTFE), polyurethane (PU), polyvinyl chloride (PVC), polystyrene, neoprene, nitrile, nylon, and polyamide. In some embodiments, a reaction vessel may be comprised of glass and/or a ceramic. The glass may, in some instances, be an expansion-resistant glass (e.g., borosilicate glass, fused quartz, or the like). In some embodiments, an Eppendorf tube may be a reaction vessel. In some embodiments, a reaction vessel may have a substantially flat bottom (e.g., the reaction vessel can stand on its own), a substantially round bottom, or a substantially conical bottom. In some embodiments, a reaction vessel may be formed of a material that is pierceable (e.g., a pierceable vial), which may enable a hole to be pierced into the internal cavity of the reaction vessel to allow contents of the reaction vessel to flow out and be used as part of a test procedure.

d. Detection Device

In some embodiments of the present technology, a lateral-flow assay (“LFA”) strip (e.g., the LFA strip 460) may be used to test for one pathogen or a plurality of different pathogens or target nucleic-acid sequences (also referred to as “target nucleic acids” herein) in a single test procedure. In some embodiments, the LFA strip may provide results that may be read or interpreted in a non-clinical setting by a lay person (e.g., a person not trained in laboratory procedures). The LFA strip may be comprised of reactants for indicating the presence (or absence) of one or more target nucleic acid sequence(s). In some embodiments, the LFA strip may be configured to detect two or more target nucleic acid sequences. In some embodiments, one or more target nucleic-acid sequence(s) may be detected using a colorimetric assay on the LFA strip. In some embodiments, the LFA strip may be comprised of one or more fluid-transporting layer(s), which may be comprised of one or more absorbent material(s) that allow fluid transport (e.g., via capillary action). Non-limiting examples of suitable materials may include polyethersulfone, cellulose, polycarbonate, nitrocellulose, sintered polyethylene, and glass fibers.

e. Heater

Although FIG. 5A shows the heater 540 and the detector 400 to be separate units, in some embodiments of the present technology, a “chimney-type” detector may have an integrated or built-in heater (e.g., a heating element may surround a chimney of the “chimney-type” detector). In some embodiments, the heater may be a printed circuit board (PCB) heater. For example, the PCB heater may be comprised of a bonded PCB with a microcontroller, thermistors, and/or resistive heater(s). In some embodiments, the heater may be comprised of a battery-powered heat source, a USB-powered heat source, a hot plate, a heating coil, and/or a hot water bath. In some embodiments, the heater may be contained within a thermally insulated housing to ensure user safety. In some embodiments, the heater may be an off-the-shelf consumer-grade device. In some embodiments, the heater may be a thermocycler or other specialized laboratory equipment known in the art. In some embodiments, the heater may be configured to receive a reaction vessel (e.g., a reaction tube).

In some embodiments of the present technology, the heater may be pre-programmed with one or more protocol(s). In some embodiments, the heater may be pre-programmed with a lysis heating protocol and/or an amplification heating protocol. A lysis heating protocol generally may refer to a set of one or more temperature(s) and one or more time period(s) that facilitate lysis of a sample. An amplification heating protocol generally may refer to a set of one or more temperature(s) and one or more time period(s) that facilitate nucleic acid amplification. In some embodiments, the heater may be comprised of an auto-start mechanism that corresponds to a temperature profile needed for lysis and/or amplification. That is, a user may insert a reaction vessel into the heater, and the insertion may cause the heater automatically to run a lysis and/or amplification heating protocol. In some embodiments, the heater may be controlled by a mobile application.

f. Test Methodologies

As noted above, a communicable disease may be detected by detecting a target nucleic-acid sequence indicative of the disease. Target nucleic-acid sequences and techniques that may be used for their detection are described below.

Target Nucleic-Acid Sequences

Diagnostic test apparatuses and test methods of the technology presented herein, in some embodiments, may be used to detect the presence or absence of any target nucleic-acid sequence (e.g., from any pathogen of interest). Target nucleic-acid sequences may be associated with a variety of diseases or disorders, as described below. In some embodiments of the present technology, the diagnostic test apparatuses and test methods may be used to diagnose at least one disease or disorder caused by a pathogen. In certain instances, the diagnostic test apparatuses and test methods may be configured to detect a nucleic acid encoding a protein (e.g., a nucleocapsid protein) of SARS-CoV-2, which is the virus that causes COVID-19. In some embodiments, the diagnostic test apparatuses and test methods may be configured to identify particular strains of a pathogen (e.g., a virus). In certain embodiments, a diagnostic test apparatus may utilize and be comprised of an LFA strip comprised of a first test line configured to detect a nucleic acid sequence of SARS-CoV-2 and a second test line configured to detect a nucleic acid sequence of a SARS-CoV-2 virus having a D614G mutation (i.e., a mutation of the 614^{th} amino acid from aspartic acid (D) to glycine (G)) in its spike protein. In some embodiments, one or more target nucleic-acid sequences may be associated with a single-nucleotide polymorphism (SNP). In certain cases, the diagnostic test apparatuses and test methods described herein may be used for rapid genotyping to detect the presence or absence of a SNP, which may affect medical treatment.

In some embodiments of the present technology, the diagnostic test apparatuses and test methods described herein may be configured to diagnose two or more diseases or disorders. This may be referred to herein as multiplexed testing. In certain cases, for example, a diagnostic test apparatus may utilize and be comprised of an LFA strip comprised of a first test line configured to detect a nucleic acid sequence of SARS-CoV-2, a second test line configured to detect a nucleic acid sequence of an influenza virus (e.g., an influenza A virus), and a third line configured to detect a nucleic acid sequence of another influenza virus (e.g., an influenza B virus). In some embodiments, a diagnostic test apparatus may utilize and be comprised of an LFA strip comprised of a first test line configured to detect a nucleic acid sequence of a virus and a second test line configured to detect a nucleic acid sequence of a bacterium. In some embodiments, a diagnostic test apparatus may utilize and be comprised of an LFA strip comprised of four or more test lines (e.g., test lines configured to detect SARS-CoV-2, SARS-CoV-2 D614G, an influenza type A virus, and an influenza type B virus). In some embodiments, a diagnostic test apparatus may utilize and be comprised of an LFA strip comprised of five or more test lines (e.g., test lines configured to detect SARS-CoV-2, SARS-CoV-2 D614G, an influenza type A virus, an influenza type B virus, and a bacterium).

Lysis of Samples

In some embodiments of the present technology, lysis may be performed on a sample by chemical lysis (e.g., exposing the sample to lysis reagent(s)) and/or thermal lysis (e.g., heating the sample). In chemical lysis, lysis may be performed by the lysis reagent(s). In some embodiments, the lysis reagent(s) may comprise one or more enzyme(s). Non-limiting examples of suitable enzymes may include lysozyme, lysostaphin, zymolase, cellulose, protease, and glycanase. In some embodiments, the lysis reagent(s) may comprise one or more detergent(s). Non-limiting examples of suitable detergents may include sodium dodecyl sulphate (SDS), Tween (e.g., Tween 20, Tween 80), 3-[(3-cholamidopropyl)dimethylammonio]-1-propanesulfonate (CHAPS), 3-[(3-cholamidopropyl)dimethylammonio]-2-hydroxy-1-propanesulfonate (CHAPSO), Triton X-100, and NP-40.

In some embodiments of the present technology, at least one of the lysis reagent(s) may be in solid form (e.g., lyophilized, dried, crystallized, air jetted, etc.). In some cases, all of the lysis reagent(s) may be in solid form (e.g., lyophilized, dried, crystallized, air jetted, etc.). In certain embodiments, one or more solid lysis reagent(s) may be in the form of a lysis pellet, or capsule, or gelcap, or tablet. The lysis pellet, or capsule, or gelcap, or tablet may comprise any lysis reagent described herein. In certain embodiments, the lysis pellet, or capsule, or gelcap, or tablet may comprise one or more additional reagent(s) (e.g., reagent(s) to reduce or eliminate cross contamination). In a particular, non-limiting embodiment, the lysis pellet, or capsule, or gelcap or tablet may comprise Thermolabile Uracil-DNA Glycosylase (UDG) (e.g., at a concentration of about 0.02 U/uL) and murine RNAse inhibitor (e.g., at a concentration of about 1 U/uL).

In some embodiments of the present technology, the lysis pellet, or capsule, or gelcap, or tablet may be shelf stable for a relatively long period of time. In certain embodiments, the lysis pellet, or capsule, or gelcap, or tablet may be shelf stable for at least 1 month, at least 3 months, at least 6 months, at least 1 year, at least 5 years, or at least 10 years.

In some embodiments, of the present technology, the lysis pellet, or capsule, or gelcap, or tablet may be thermostabilized and may be stable across a wide range of temperatures. In some embodiments, the lysis pellet, or capsule, or gelcap, or tablet may be stable at a temperature of at least 0° C., at least 10° C., at least 20° C., at least 37° C., at least 65° C., or at least 100° C.

As noted above, thermal lysis may be accomplished by applying heat to the sample. In some embodiments of the present technology, thermal lysis may be performed by applying a lysis heating protocol comprised of heating the sample at one or more temperature(s) for one or more time period(s) or duration(s) using any suitable heater (e.g., the heater 540).

Nucleic-Acid Amplification

Following lysis, one or more target nucleic acid(s) (e.g., a nucleic acid of a target pathogen) may be amplified, according to some embodiments of the present technology. In some cases, a target pathogen may have RNA as its genetic material. In certain instances, for example, a target pathogen may be an RNA virus (e.g., a coronavirus, an influenza virus). In some such cases, the target pathogen's RNA may need to be reverse transcribed to DNA prior to amplification.

In some embodiments of the present technology, reverse transcription may be performed by exposing lysate (i.e., product(s) of lysis) to one or more reverse-transcription reagent(s). In certain instances, the reverse-transcription reagent(s) may comprise a reverse transcriptase, a DNA-dependent polymerase, and/or a ribonuclease (RNase). A reverse transcriptase may refer generally to an enzyme that transcribes RNA to complementary DNA (cDNA) by polymerizing deoxyribonucleotide triphosphates (dNTPs). An RNase may refer generally to an enzyme that catalyzes the degradation of RNA. In some cases, an RNase may be used to digest RNA from an RNA-DNA hybrid.

In some embodiments of the present technology, DNA may be amplified according to any nucleic-acid amplification method known in the art. In some embodiments, the nucleic-acid amplification method may be an isothermal amplification method. Isothermal amplification methods may include, but are not limited to, loop-mediated isothermal amplification (LAMP), recombinase polymerase amplification (RPA), and nicking enzyme amplification reaction (NEAR). In some embodiments of the present technology, an isothermal amplification method that may be performed in a test procedure may be comprised of applying heat to a sample. For example, heat may be applied to a sample fluid containing the sample. In certain instances, the isothermal amplification method may be comprised of applying an amplification heating protocol, which may be comprised of heating the sample at one or more temperature(s) for one or more time period(s) using any appropriate heater (e.g., the heater 540).

Molecular Switches

As described herein, a sample may undergo lysis and amplification prior to detection. Reagents associated with lysis and/or amplification may be in solid form (e.g., lyophilized, dried, crystallized, air jetted, etc.). In certain embodiments of the present technology, one or more (and, in some cases, all) of the reagents necessary for lysis and/or amplification may be present in a single pellet, capsule, gelcap, or tablet. In some embodiments, the pellet, capsule, gelcap, or tablet may be comprised of two or more enzymes, and it may be necessary for the enzymes to be activated in a particular order. Therefore, in some embodiments, the enzyme-containing tablet, pellet, capsule, or gelcap may further be comprised of one or more molecular switches.

Molecular switches, as used or described herein, may be molecules that, in response to certain conditions, reversibly switch between two or more stable states. In some embodiments, a condition that causes the molecular switch to change its configuration may be associated with any one or any combination of: pH, light, temperature, an electric current, microenvironment, and presence of ions and/or other ligands. In one embodiment, the condition may be heat. In some embodiments, the molecular switches described herein may be aptamers. Aptamers may refer generally to oligonucleotides or peptides that may bind to specific target molecules (e.g., the enzymes described herein). The aptamers, upon exposure to heat or other conditions, may dissociate from the enzymes. With use of molecular switches, one or more of the processes described herein (e.g., lysis, decontamination, reverse transcription, and amplification, etc.) may be performed in a single test tube with a single enzymatic tablet, pellet, capsule, or gelcap.

CRISPR/Cas Techniques

In some embodiments of the present technology, CRISPR/Cas detection techniques may be used to detect a target nucleic-acid sequence. For example, one or more CRISPR/Cas detection reagent(s) may be included on an LFA strip. CRISPR generally may refer to Clustered Regularly Interspaced Short Palindromic Repeats, and Cas generally may refer to a particular family of proteins. In some embodiments, the CRISPR/Cas detection platform or techniques may be combined with an isothermal amplification method to create a single-step reaction (Joung et al., “Point-of-care testing for COVID-19 using SHERLOCK diagnostics,” 2020). For example, amplification and CRISPR detection may be performed using reagents having compatible chemistries (e.g., reagents that do not interact detrimentally with one another and are sufficiently active to perform amplification and detection). In some embodiments, CRISPR/Cas detection may be combined with LAMP.

It should be understood that the features and details described above may be used, separately or together in any combination, in any of the embodiments discussed herein.

Some aspects of the present technology may be embodied as one or more methods. Acts performed as part of a method may be ordered in any suitable way. Accordingly, embodiments may be constructed in which acts may be performed in an order different than described or illustrated, which may include performing some acts simultaneously, even though they may be shown or described as sequential acts in illustrative embodiments.

Aspects described in one embodiment may be combined in any manner with aspects described in other embodiments.

Any use of ordinal terms such as “first,” “second,” “third,” etc., in the description and the claims to modify an element does not by itself connote any priority, precedence, or order of one element over another, or the temporal order in which acts of a method are performed, but is or are used merely as labels to distinguish one element or act having a certain name from another element or act having a same name (but for use of the ordinal term) to distinguish the elements or acts.

The indefinite articles “a” and “an,” as used herein in the specification and in the claims, unless clearly indicated to the contrary, should be understood to mean “at least one.”

Any use herein, in the specification and in the claims, of the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

Any use herein, in the specification and in the claims, of the phrase “equal” or “the same” in reference to two values (e.g., distances, widths, etc.) should be understood to mean that two values are the same within manufacturing tolerances. Thus, two values being equal, or the same, may mean that the two values are different from one another by ±5%.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. As used herein in the specification and in the claims, the term “or” should be understood to have the same meaning as “and/or” as defined above.

The terms “approximately” and “about” if used herein may be construed to mean within ±20% of a target value in some embodiments, within ±10% of a target value in some embodiments, within ±5% of a target value in some embodiments, and within ±2% of a target value in some embodiments. The terms “approximately” and “about” may equal the target value.

The term “substantially” if used herein may be construed to mean within 95% of a target value in some embodiments, within 98% of a target value in some embodiments, within 99% of a target value in some embodiments, and within 99.5% of a target value in some embodiments. In some embodiments, the term “substantially” may equal 100% of the target value.

What is claimed is:

1. A reagent carrier, comprising:
a cap configured to fit on an opening of a reaction vessel; and
a reagent confined by the cap.

2. The reagent carrier of claim 1, wherein the cap is configured to release the reagent when a user manipulates the cap while the cap is fitted on the opening of the reaction vessel.

3. The reagent carrier of claim 2, wherein the cap is configured to release the reagent when the user twists the cap from a first position to a second position while the cap is fitted on the opening of the reaction vessel or when the user pushes on a surface of the cap while the cap is fitted on the opening of the reaction vessel.

4. The reagent carrier of claim 1, wherein the cap is a blister cap comprised of a blister pack configured to contain the reagent.

5. The reagent carrier of claim 4, wherein the blister cap is configured to release the reagent when the blister cap is pushed by a user to cause the blister pack to rupture and release the reagent from confinement.

6. The reagent carrier of claim 1, wherein the cap is comprised of a basket configured to contain the reagent.

7. The reagent carrier of claim 6, wherein the basket is structured to enable the reagent to form a solution with a liquid when the basket is at least partially immersed in the liquid.

8. The reagent carrier of claim 1, wherein the cap is comprised of:
a base portion configured to be attachable to the reaction vessel; and
a retainer portion attached to the base portion and configured to contain the reagent.

9. The reagent carrier of claim 8, wherein the retainer portion is comprised of a pliable elastomeric structure configured to deform to release the reagent during attachment of the base portion to the reaction vessel.

10. The reagent carrier of claim 9, wherein:
the retainer portion is comprised of a film configured to retain the reagent relative to the base portion, and
the film is configured to break to release the reagent when the base portion is attached to the reaction vessel.

11. The reagent carrier of claim 1, wherein the reagent is comprised of an amplification agent or a lysing agent.

12. The reagent carrier of claim 1, wherein the cap is comprised of:
an attachment portion configured to attach to the reaction vessel, and
a flip-top lid movably attached to the attachment portion.

13. A test apparatus for use in a diagnostic test, the apparatus comprising:
a detector;
a reaction vessel configured to be received by the detector; and
a first cap comprised of a first reagent, wherein the first cap is configured to fit on an opening of the reaction vessel.

14. The test apparatus of claim 13, wherein the first cap is configured to release the first reagent into the reaction vessel when a user manipulates the first cap while the first cap is fitted on the opening of the reaction vessel.

15. The test apparatus of claim 14, wherein the first cap is:
a blister cap comprised of a blister pack configured to contain the first reagent and to release the first reagent when the blister cap is pushed by a user to cause the blister pack to release the first reagent, or
a caged cap comprised of a retainer portion configured to deform or break to release the first reagent when the first cap is fitted on the opening of the reaction vessel.

16. The test apparatus of claim 13, wherein the first cap is comprised of a basket configured to contain the first reagent and to enable a fluid to contact the first reagent when the basket is at least partially immersed in the fluid.

17. The test apparatus of claim 13, further comprising:
a lateral-flow assay strip housed in the detector.

18. A test kit for use in a diagnostic test, the test kit comprising:
a reaction vessel; and
a first cap comprised of a first reagent, wherein the first cap is configured to fit on an opening of the reaction vessel.

19. The test kit of claim 18, further comprising any one or any combination of:
a detector;
a lateral-flow assay strip;
a colorimetric assay strip;
a swab;
a heater;
a mobile application configured to guide use of the test kit;
a readout device; and
a second comprised of a second reagent, wherein the second cap is configured to fit on the opening of the reaction vessel.

20. The test kit of claim 18, wherein the first reagent is comprised of a lysing agent or an amplification agent.
